(19) United States
(12) Patent Application Publication
(10) Pub. No.: US 2013/0177158 A1
(43) Pub. Date: Jul. 11, 2013

(54) METHOD FOR SENDING MULTIPLE PCM AUDIO CHANNELS OVER AN INDUSTRY-STANDARD STEREO LINK

(71) Applicants: Ted Klein, Saint Bonifacius, MN (US); Dan Germann, Burnsville, MN (US)

(72) Inventors: Ted Klein, Saint Bonifacius, MN (US); Dan Germann, Burnsville, MN (US)

(73) Assignee: Digital Audio Labs, Chanhassen, MN (US)

(21) Appl. No.: 13/681,107

(22) Filed: Nov. 19, 2012

Related U.S. Application Data
(60) Provisional application No. 61/561,148, filed on Nov. 17, 2011.

(51) Int. Cl. H04R 5/00

(52) U.S. Cl. CPC H04R 5/00
USPC 381/17

(57) ABSTRACT

A system and method for sending a multi-channel PCM audio stream over a link. An encoder combines a plurality of individual PCM audio channels into a multi-channel audio stream and encodes the multi-channel audio stream to maintain channel order, wherein encoding includes using a bit of one of the encoded channels to mark the encoded channel as a first channel. A transmitter transmits the encoded multi-channel audio stream over the link. A receiver receives the transmitted and encoded multi-channel audio stream and recovers the encoded multi-channel audio stream and one or more clocks. A decoder locates the first channel and de-interleaves the multiple audio streams into individual PCM-encoded audio channels, wherein locating includes looking for the bit that marks the first channel.

### CLAIM OF PRIORITY

This patent application claims the benefit of priority under 35 U.S.C. Section 119(e), to U.S. Provisional Patent Application Ser. No. 61/561,148, filed Nov. 17, 2011 (Attorney Docket No. 3543.001PRV), which is hereby incorporated by reference herein in its entirety.

### Background

Audio content has evolved from “monaural” audio, requiring a single audio channel, to “stereo” audio, requiring two channels, to “surround sound” audio, requiring four or more channels. As the number of channels increases, so does the complexity of sending the audio content. Sending multiple channels over an analog medium requires additional cabling proportional to the number of channels. Sending multiple channels over a digital medium, such as USB or IEEE-1394, can be done with a single cable, but involves additional hardware and software infrastructure that is either not available or complex and expensive to develop.

Surround-sound encoding methods, such as Dolby Digital®, allow surround sound audio to be sent over a single S/PDIF link. But these encoding methods do not transmit the audio in a standard PCM format; rather, they send blocks of audio that have been encoded using a lossy compression algorithm. This means that the transmitting end either must use pre-encoded audio, which means that it is no longer possible to mix multiple audio sources to dynamically create an audio performance, or the encoding must be done at the transmitting end after mixing and prior to transmission, which requires substantial computing power.

U.S. Pat. No. 7,702,005 describes a method for transmitting audio data. The patent describes a modified S/PDIF link that carries multiple PCM channels, using a non-standard AES3 preamble to delineate the multi-channel frames. While that has the advantage of using a single cable, it requires custom S/PDIF interface ICs that use a non-standard AES3 preamble. This is not a viable solution because the required custom S/PDIF interface ICs are not commercially available, and development of such ICs requires substantial investment.

### BRIEF DESCRIPTION OF DRAWINGS

FIG. 1 shows a system for transmitting multiple PCM audio signals over a single link;

FIG. 2 shows an encoding scheme that can be used in the system of FIG. 1; and

FIG. 3 illustrates a method of sending and receiving an encoded PCM stream.

### DETAILED DESCRIPTION

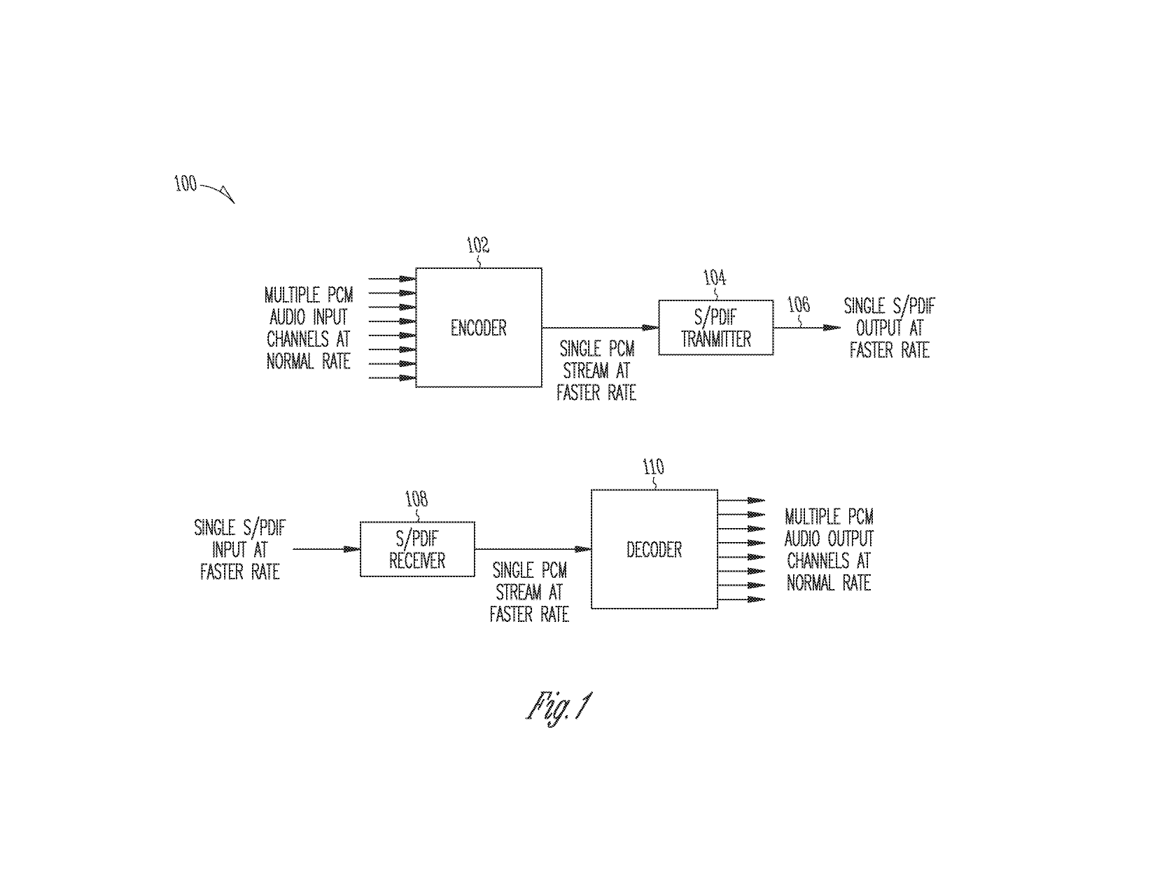

FIG. 1 shows a block diagram of a system 100 for transmitting multiple PCM audio signals over a single link. System 100 includes an encoder 102, a transmitter 104, a link 106, a receiver 108, and a decoder 110. On the transmitting end, multiple PCM-encoded audio channels, at the normal audio sample rate, are fed into Encoder 102, which interleaves the audio channels and marks one or more of the channels. The encoder then sends the multiple-channel encoded audio stream, at a faster sample rate, to a standard S/PDIF transmitter 104, which sends the multiple-channel audio stream over a standard biphase-encoded S/PDIF link 106. On the receiving end, the biphase-encoded audio stream is received by a standard S/PDIF receiver 108, where clocks and data are recovered. The data is sent to a Decoder 110, which locates the marked channel(s) and de-interleaves the multiple audio streams into individual PCM-encoded audio channels at the normal audio sample rate.

Many systems that process audio already include one or more processors that manipulate the audio (e.g., to mix channels together or apply equalization (bass/treble controls) or compression (dynamic volume adjustment)). It is both convenient and cost-effective to use such processors to perform the Encoding and Decoding operations.

Systems that do not include processors can use hardware, such as PLAs, CPLDs, FPGAs, discrete logic or other similar hardware devices, to perform the Encoding and Decoding operations.

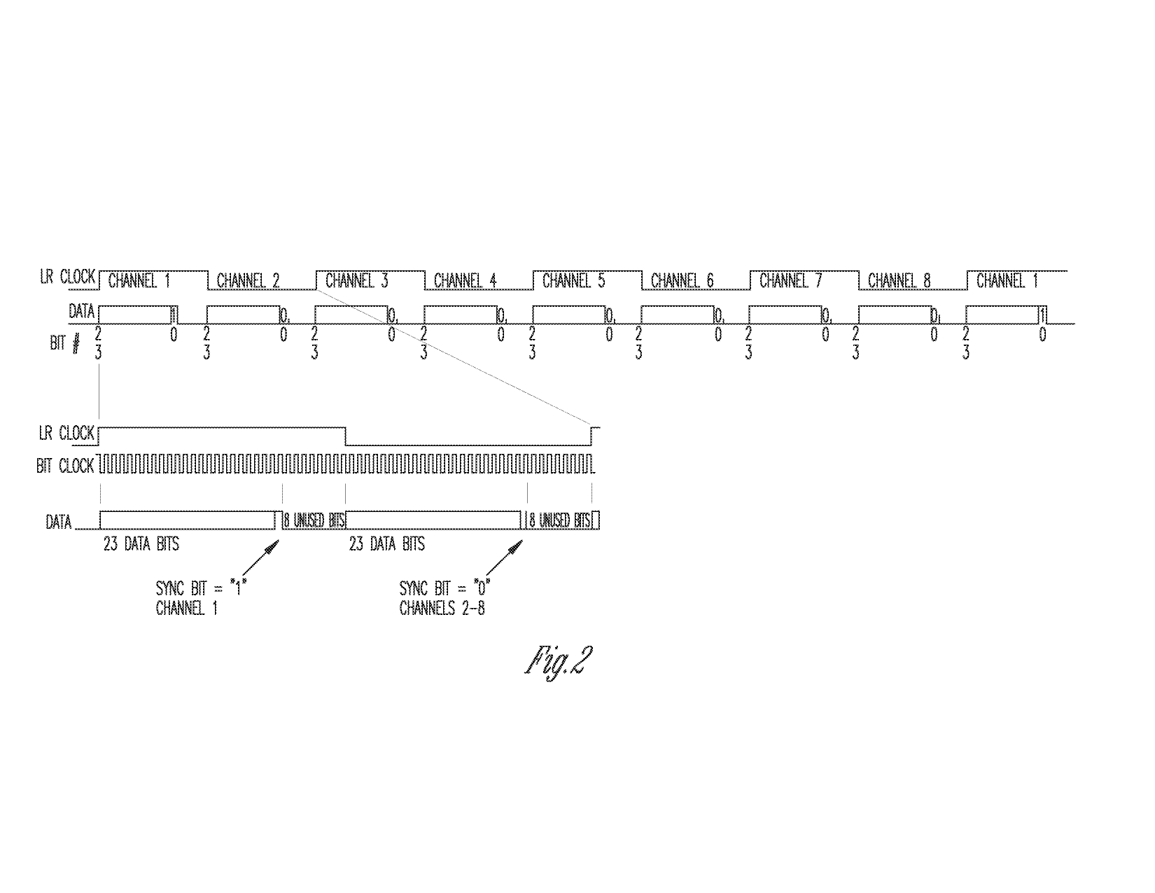

One embodiment of the present invention uses an easily computed, and therefore computationally low-overhead, method to encode the audio channels. Since S/PDIF carries 24 bits of audio information, and since the dynamic range of 24-bit audio far exceeds the requirements of most audio applications, the least significant bit (LSB) of the audio data is used to mark the first channel. Encoder 102 turns on (sets) the LSB on the first channel's sample, and turns off (resets) the LSB on the samples for all other channels. Thus, it is a simple matter for Decoder 110 to find the first channel's sample by inspecting the LSBs of the incoming audio stream. A diagram showing this encoding is found in FIG. 2.

Since S/PDIF is not a transport mechanism that guarantees delivery of intact information, in one embodiment Decoder 110 includes logic to ensure a damaged sample does not cause a loss of synchronization (e.g., when the LSB is not set on the first channel or when the LSB is set on a non-first sample). Some embodiments will have both a “lock” requirement that sees the LSB set on the first sample of multiple frames of data, and an “unlock” requirement that sees the LSB not set on the first sample of multiple frames of data.

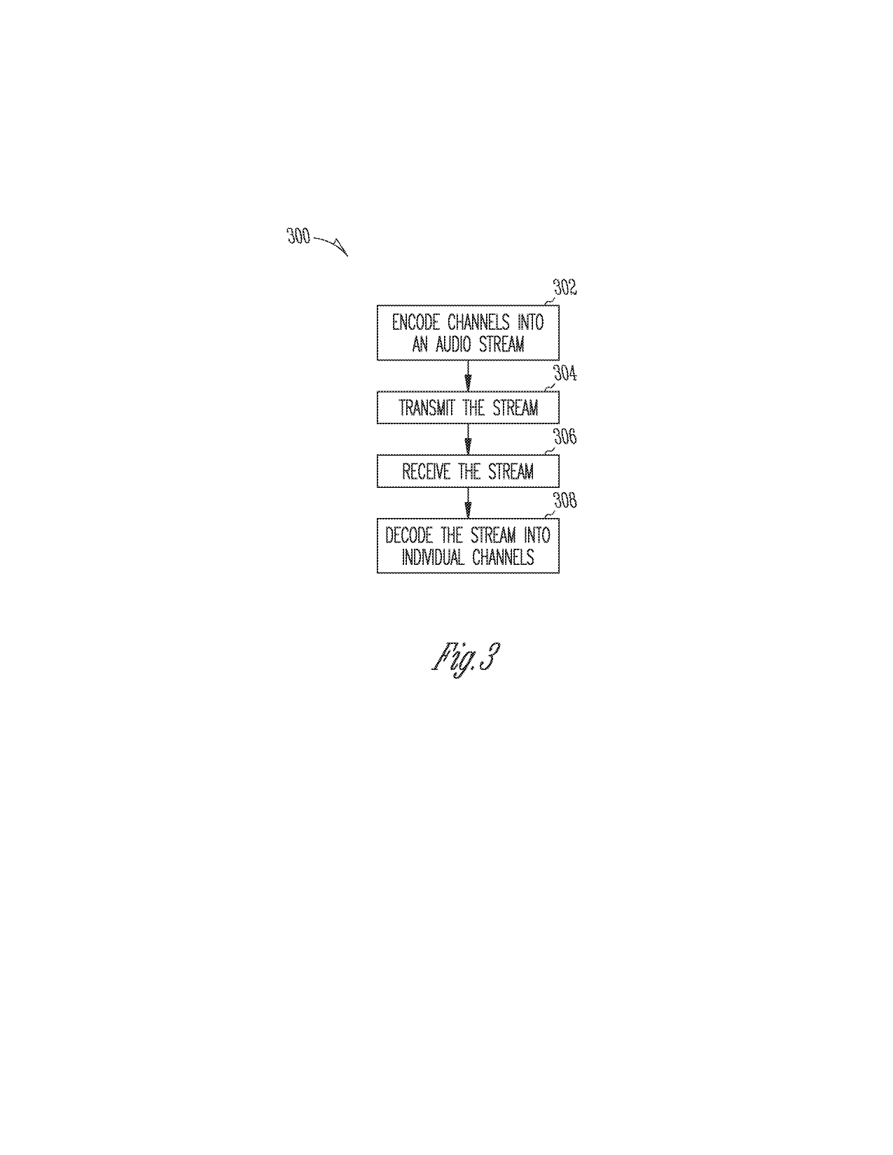

In one embodiment, as is shown in FIG. 3, multiple PCM audio channels are encoded into a single PCM stream at 302, which interleaves the audio channels and marks one or more of the channels. In the embodiment shown in FIG. 2, the interleaving of channels is done on a sample-by-sample basis, with eight channels forming a frame. In another embodiment, the channels are interleaved on a frame-by-frame basis, with each frame made up of successive samples of the same channel. In this embodiment, the synchronization bit serves as an indication of the start of a new frame of channel one samples. Another example interleaving embodiments include assigning two or more channels per frame, and assigning multiple successive frames per channel.

Returning to FIG. 3, the encoded PCM stream is transmitted at 304, which sends the multiple-channel audio stream over a link 106 and received by a receiver 108 at 306, where clocks and data are recovered. Receiver 108 then transmits the encoded PCM stream to decoder 110 for decoding at 308. Decoder 110 locates the marked channel(s) and de-interleaves the multiple audio streams into individual PCM-encoded audio channels at the normal audio sample rate.

In one example embodiment, system 100 maintains a constant data rate through the entire system (Encoder→Decoder). In one such embodiment, the encoded audio is sent at a higher sample rate than the incoming audio streams. Since S/PDIF is a two-channel (stereo) transport, in one embodiment the encoded audio stream is transmitted over the S/PDIF link at a rate that is greater than or equal to the number of channels divided by two. For example, a system that sends 4 channels of 44.1 kHz audio would be sent at an S/PDIF rate of 88.2 kHz. This ensures that the audio streams maintain time coherency.

Although the present invention has been described with respect to using S/PDIF as the link between the transmitter and receiver, other similar links, such as AES/EBU, can also be used.

Those skilled in the art will realize that there are numerous ways to implement the form and detail of the present invention that are still within the spirit and scope of the invention.

What is claimed is:

1. A method for sending a multi-channel PCM audio stream over a link, comprising:
combining a plurality of individual PCM audio channels into a multi-channel audio stream, wherein combining includes interleaving the audio channels within the stream;
encoding the multi-channel audio stream to maintain channel order; and
transmitting the encoded multi-channel audio stream over a link at a rate that is greater than or equal to the original audio sample rate multiplied by the number of channels and divided by two.

2. The method of claim 1, wherein encoding to maintain channel order includes marking a bit of one of the encoded channels to serve as a synchronization bit.

3. The method of claim 1, where encoding to maintain channel order includes manipulating channel sample data to mark one or more of the channels of audio in a way that can be subsequently detected by a decoder.

4. The method of claim 1, where encoding to maintain channel order includes sampling each channel to form an m-bit audio sample for each channel, wherein m is greater than one, and setting the least significant bit (LSB) of each sample to ‘1’ for the first channel and to ‘0’ for all other channels.

5. The method of claim 1, where encoding to maintain channel order includes sampling each channel to form an audio sample for each channel and setting the least significant bit (LSB) of every nth sample to ‘1’ for the first channel and to ‘0’ for all other channels, wherein n is greater than or equal one.

6. A method for receiving an encoded multi-channel audio stream over a link, wherein the multi-channel audio stream is encoded using a marking bit of one of the encoded channels to mark the encoded channel as a first channel, the method comprising:
receiving the encoded multi-channel audio stream;
recovering the encoded multi-channel audio stream and one or more clocks; and
decoding the multi-channel audio stream, wherein decoding includes locating the marked channel and de-interleaving the multiple audio streams into individual PCM-encoded audio channels, wherein de-interleaving includes looking for the bit that marks the first channel.

7. The method of claim 6, where the encoded multi-channel audio stream includes m-bit samples of audio for each channel, wherein m is greater than one, wherein one of the m-bits is used as the marking bit.

8. The method of claim 6, where the encoded multi-channel audio stream includes m-bit samples of audio for each channel, wherein m is greater than one, wherein one of the m-bits is used as the marking bit, and wherein the marking bit is only set in the nth sample for the first channel and is clear otherwise, wherein n is greater than or equal to one.

9. The method of claim 6, where the encoded multi-channel audio stream includes m-bit samples of audio for each channel, wherein m is greater than one, wherein the least significant bit of each sample is used as the marking bit, and wherein the marking bit is only set in the nth sample for the first channel and is clear otherwise, wherein n is greater than or equal to one.

10. The method of claim 8, wherein the marking bit is only set in the nth sample for the first channel and is cleared otherwise and wherein decoding further includes:
determining if the marking bit is set when it is supposed to be cleared; and
if the marking bit is set when it is supposed to be cleared, noting a synchronization problem.

11. A system for sending a multi-channel PCM audio stream over a link, comprising:
an encoder, wherein the encoder combines a plurality of individual PCM audio channels into a multi-channel audio stream and encodes the multi-channel audio stream to maintain channel order, wherein combining includes interleaving the audio channels within the stream and wherein encoding includes using a bit of one of the encoded channels to mark a sample of the encoded channel as sample from a first channel;
a transmitter, wherein the transmitter transmits the encoded multi-channel audio stream over the link;
a receiver, wherein the receiver receives the transmitted and encoded multi-channel audio stream and recovers the encoded multi-channel audio stream and one or more clocks; and
a decoder, wherein the decoder locates the first channel and de-interleaves the multiple audio streams into individual PCM-encoded audio channels, wherein locating includes looking for the bit that marks the first channel.

12. The system of claim 11, where the encoded multi-channel audio stream includes m-bit samples of audio for each channel, wherein m is greater than one, wherein the least significant bit is used as the marking bit.

13. The system of claim 12, wherein the marking bit is only set in the nth sample for the first channel and is cleared otherwise, wherein n is an integer greater than zero; and
wherein the decoder determines if the marking bit is set for channels other than the first channel and, if the marking bit is set for channels other than the first channel, notes a synchronization problem.

14. The system of claim 11, where the decoder looks for the least significant bit (LSB) of the first m-bit audio sample being set to ‘1’, and the LSB of subsequent samples in the same frame being set to ‘0’.

15. The system of claim 11, wherein the link is a S/PDIF link.

16. The system of claim 11, wherein the link is a AES/EBU link.

17. The system of claim 11, wherein the marked first channel sample is placed at the start of a frame.

18. A transmitter system for sending a multi-channel PCM audio stream over a link, comprising:
an encoder, wherein the encoder combines a plurality of individual PCM audio channels into a multi-channel audio stream and encodes the multi-channel audio stream to maintain channel order, wherein combining includes interleaving the audio channels within the stream and wherein encoding includes using a bit of one of the encoded channels to mark the encoded channel as a first channel; and
a transmitter, wherein the transmitter transmits the encoded multi-channel audio stream over the link at a rate that is greater than or equal to the original audio sample rate multiplied by the number of channels and divided by two.

19. The system of claim 18, wherein the encoder maintains channel order by marking a bit of one of the encoded channels as a synchronization bit.

20. The system of claim 18, where the encoder maintains channel order by manipulating channel sample data to mark one or more of the channels of audio in a way that can be subsequently detected by a decoder.

21. The method of claim 18, where the encoder samples each channel to form an m-bit audio sample for each channel and maintains channel order by setting the least significant bit (LSB) of each nth sample to ‘1’ for the first channel and to ‘0’ for all other channels, wherein n is an integer greater than or equal to one.

22. A receiver system for receiving an encoded multi-channel audio stream over a link, wherein the multi-channel audio stream is encoded using a bit of one of the encoded channels to mark the encoded channel as a first channel, the system comprising:
a receiver, wherein the receiver receives the encoded multi-channel audio stream and recovers the encoded multi-channel audio stream and one or more clocks; and
a decoder, wherein the decoder locates the marked channel and de-interleaves the multiple audio streams into individual PCM-encoded audio channels, wherein de-interleaving includes looking for the bit that marks the first channel.

23. The system of claim 22, where the encoded multi-channel audio stream includes m-bit samples of audio for each channel, wherein m is greater than 1, wherein one of the m-bits is used as the marking bit.

24. The system of claim 23, wherein the marking bit is only set in the nth sample for the first channel, wherein n is an integer greater than or equal to one, and is clear otherwise; and
wherein the decoder determines if the marking bit is set for channels other than the first channel and, if the marking bit is set for channels other than the first channel, notes a synchronization problem.

25. The system of claim 23, wherein the marking bit is only set in the nth sample for the first channel, wherein n is an integer greater than or equal to one, and is clear otherwise; and
wherein the decoder determines the first channel, determines if the marking bit is cleared for the nth sample of the first channel and, if the marking bit is cleared for the nth sample of the first channel, notes a synchronization problem.
